(19) United States
(12) Patent Application Publication
(10) Pub. No.: US 2007/0284883 A1
(43) Pub. Date: Dec. 13, 2007

(54) Clean energy generation system

(76) Inventor: Joseph Cafariello, Hornell Heights (CA)

Correspondence Address: MIKE GAUTHIER, 355 GOODWILL DRIVE, BOX 400, GARSON, ON, P3L 1S7, US

(21) Appl. No.: 11/448,091

(22) Filed: Jun. 7, 2006

(51) Int. Cl. F03B 13/00; H02P 9/04

(52) U.S. Cl. 290/54

(57) ABSTRACT

The present invention relates to an inexpensive system for the production of clean energy. The system of the present invention comprises a chamber system utilizing active buoyancy of a weighted bladder to pressurize and vacuum air within said chamber thus driving rotary impellers for actuation of one or more electrical or mechanical generators.

### FIELD OF THE INVENTION

The present invention relates to an inexpensive system for the production of clean energy. The system of the present invention comprises a chamber system utilizing active buoyancy of a weighted bladder to pressurize and vacuum air within said chamber thus driving rotary impellers for actuation of one or more electrical or mechanical generators.

### BACKGROUND OF THE INVENTION

Power generation is a vital subject in meeting today's ever-increasing energy consumption needs, and along with many other methods, water powered systems have also been implemented for the generation of electrical power. For the most part, these systems have been very costly to implement and require a higher level of maintenance to function properly. Furthermore, most prior art systems alter or deface the natural landscape. Additionally, the ecosystem is greatly affected by these installations.

The inventor sought to provide mankind with systems that are inexpensive, non-obtrusive and as invisible as possible.

Through the development of the systems of the present invention, the inventor was indeed able to overcome all of the above defects in prior art systems.

The applicant has retrieved several attempts in prior art that provide means of generating electrical energy using water as a source of renewable mechanical energy. Examples of such art may be had by referencing U.S. Pat. No. 3,668,412 of Vrana, U.S. Pat. No. 4,001,596 of Kurtzbein, U.S. Pat. No. 4,326,840 of Hicks, U.S. Pat. No. 5,872,406 of Ullman, U.S. Pat. No. 6,803,670 of Peloquin, US Appl. No. 2005/0023836 of Abdalla, and JP absract 2004270674 of Toshimitsu.

### SUMMARY OF THE INVENTION

It is thus the object of the present invention to provide mankind with water-powered electrical generation systems that are inexpensive to implement, non-obtrusive to the ecosystems, and as invisible and aesthetically pleasing as possible.

In one aspect of the invention, the resulting mechanical energy created by the present system may be utilized as either a mechanical source of energy or to drive alternators thus creating electrical energy for either storage or immediate use.

Accordingly, the device of the present invention therefore provides mankind with electrical power generation systems that are inexpensive, non-obtrusive and as invisible as possible.

The utility of the present invention includes but is not limited to electrical power generation.

### BRIEF DESCRIPTION OF THE DRAWINGS

These and other advantages of the invention will become apparent upon reading the following brief description and upon referring to the drawings in which:

FIG. 1 is a semi-transparent front elevation view of the clean energy generation system of the present invention in stage 1 position.

FIG. 2 is a semi-transparent front elevation view of the clean energy generation system of the present invention in stage 2 position.

FIG. 3 is a semitransparent front elevation view of the clean energy generation system of the present invention in stage 3 position.

FIG. 4 is a semi-transparent front elevation view of the clean energy generation system of the present invention in stage 4 position.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

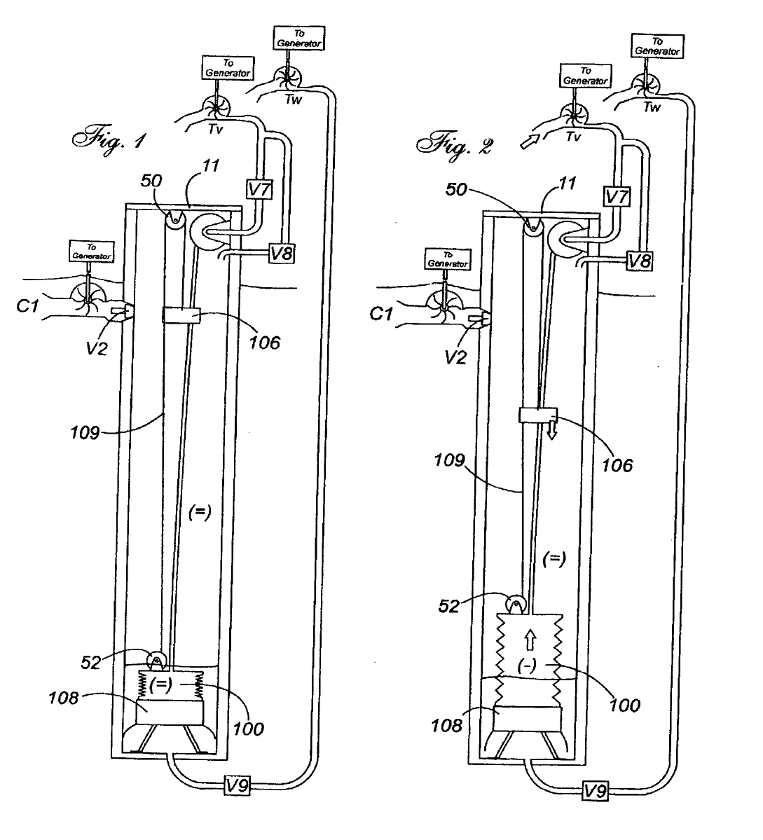

Turning to FIGS. 1 through 4, all semi-transparent front elevation views of the clean energy generation system of the present invention illustrated at stages 1 through 6 wherein the bladder assembly 100 has a lower weight 108. An upper weight 106 is fixedly attached to a tether 109. The upper weight 106 serves to apply downward pressure onto the bladder 100 so as to deplete said bladder 100 of the air within. An accumulator reel 52 located atop the bladder collects excess tether 109 and said tether 109 is rotably attached to the underside of the upper cap 11 of the chamber via a pulley 50 thus maintaining light tension on the tether 109.

In FIG. 1, all systems are in reset mode and all valves V2, V7, V8, and V9 are closed. Equilibrium is reached. Reel 50 is locked and the upper weight 106 is suspended.

In FIG. 2, reel 50 is rotable, reel 52 is locked, valve V7 is opened and the upper weight 106 descends thus tugging upward on the upper surface of the bladder 100 thus inflating said bladder 100 while air entering turbine Tv actuates said turbine; generating power until the bladder is fully inflated.

In FIG. 3, the chamber is flooded by opening the inlet valve V2, causing the inflated bladder 100 to rise, raising the attached lower weight and eventually the suspended upper weight with it.

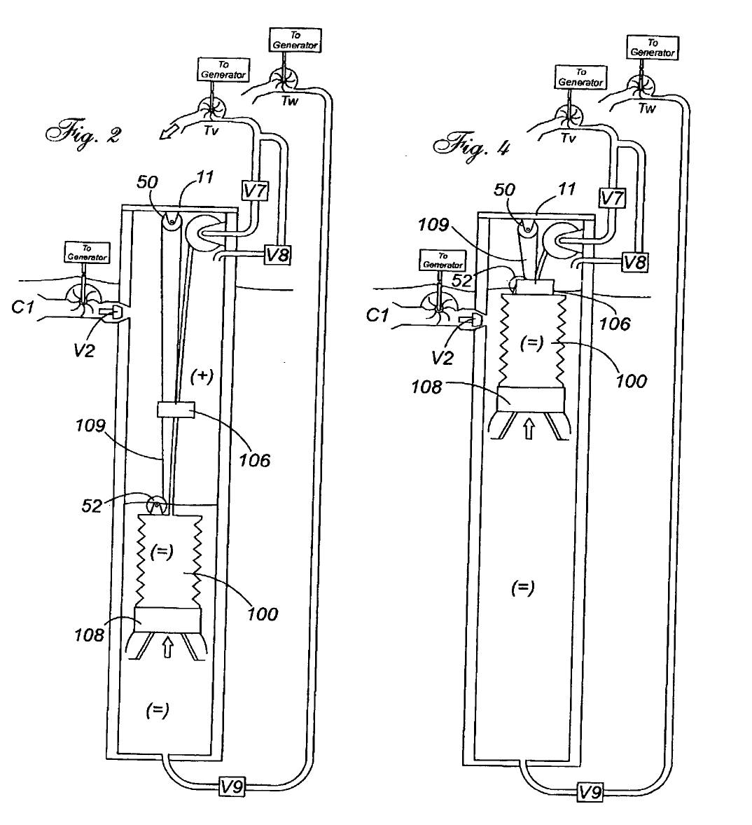

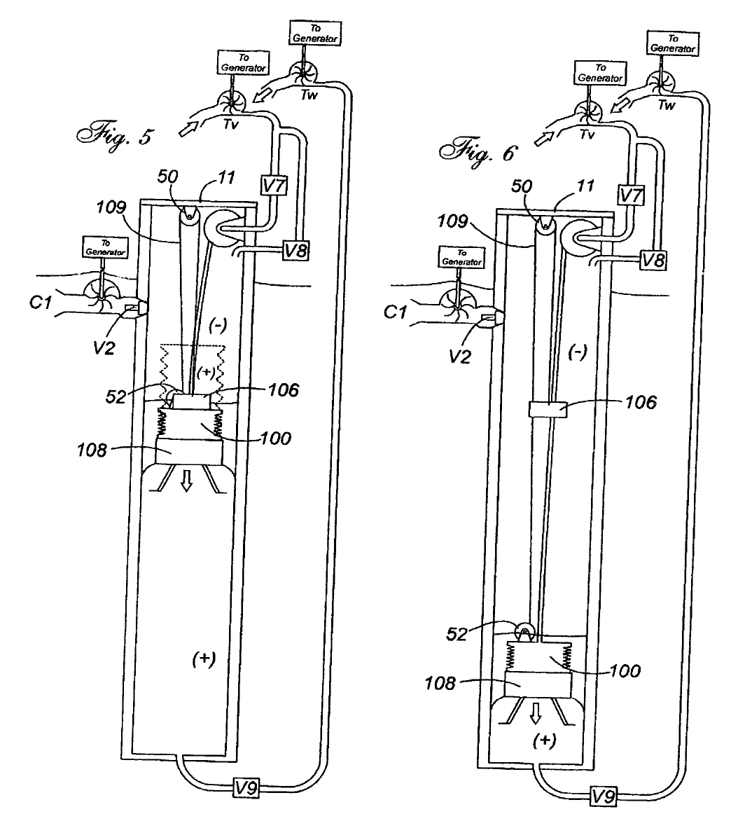

Now in FIG. 4, The bladder assembly is at its highest level within the chamber, valve V2 closes and valve V7 opens to release the pressurized air within the inflated bladder 100 thus deflating said bladder 100, the upper weight forces the bladder 100 to collapse, causing the bladder 100 to lose buoyancy, and the bladder 100 assembly descends to the bottom of the chamber with the cup seal extended outwardly against the inner wall of the chamber. The water under the cup seal within the chamber is thereby forced through opened valve V9 and up to turbine Tw thus generation energy as illustrated in FIGS. 5 and 6. The locking reel 50 is immobilized as soon as the weight 106 has fully collapsed the bladder 100 thus leaving the weight 106 suspended generally centrally in the chamber. The system is now in reset mode, ready to be filled for the cycle to start again.

What I claim as my invention:

1. The clean energy generation system of claim 1 wherein the system comprises:
a. a cylinder,
b. a bladder,
c. a tether between the chamber cap and the upper portion of the bladder,
d. a lower bladder weight
e. an upper bladder weight
f. a flow control system,
g. air communication means,
h. water communication means, and
i. impeller turbines.

2. The clean energy generation system of claim 1 wherein the cylinder further comprises: an upper removable air-tight cap, a polished hollow cylindrical interior surface, lakebed and oceanbed attachment means, a bottom portion being integral with the cylinder, an air chamber port, a reeled bladder air line, a bottom port, and a water inlet.

3. The clean energy generation system of claim 1 wherein the water inlets of the chamber further comprises: a housing sealed about an opening below the lowest of water body levels at the chamber's side wall, a water inlet mouth, an inline impeller, an impeller drive shaft output, and a flow control valve having its chamber side end conforming in shape with the inner chamber wall.

4. The clean energy generation system of claim 1 wherein the bladder assembly further comprise:
a. a weight,
b. legs below said weight,
c. a semi-resilient cup seal fixedly attached to the lower perimeter of the weight and the lower rim of said cup seal having sufficient ductility to expand in diameter to conform to the chamber's inner wall surface thus forming a seal there between,
d. an inflatable bladder fixedly attached to the upper perimeter of the weight, and
e. an air line connection means at the very top portion of the inflatable bladder

5. The clean energy generation system of claim 1 wherein the cup seal of the bladder assembly retracts from contact with the inner perimeter wall surface of its surrounding chamber when bladder is inflated, and expands outwardly in full contact against the inner perimeter wall surface of its surrounding chamber when bladder is deflated and descending.

6. The clean energy generation system of claim 1 wherein the cup seal of the bladder assembly, when deflated, pressurizes the water below said cup seal thus forcing water in the chamber below the cup seal into a bottom port in communication with an inline impeller turbine thus providing a long intermittent flow of water at said turbine.

7. The clean energy generation system of claim 1 wherein the weight portion is divided between a lower weight located below an inflatable bladder comprising the majority of the bladder assembly's total weight and an upper weight located above said inflatable bladder comprising a lesser portion of said weight.

8. The clean energy generation system of claim 1 wherein the fully inflated bladder has buoyancy greater than the sum of both lower and upper weights of the bladder assembly.

9. The clean energy generation system of claim 1 wherein the tether has a length equal to the distance between the highest point of the bladder assembly when inflated, and the underside of the chamber's cap.

10. The clean energy generation system of claim 1 wherein the turbines comprise: air driven turbines, and water driven turbines.

11. The clean energy generation system of claim 1 wherein bladder air line is arranged to be springedly reeled at the uppermost portion of the chamber so as to gather unused portion of the length of said line.

12. The clean energy generation system of claim 1 wherein the tether line is arranged to be springedly reeled at the uppermost portion of the chamber so as to gather unused portion of the length of said tether.

13. The clean energy generation system of claim 1 wherein turbine impellers are driven during occurrences comprising:
a. a deflated bladder assembly descending toward the bottom of a chamber with open communication between an opening at the bottom of said chamber and a water turbine,
b. an opened water inlet filling an empty chamber,
c. chamber air above the inner water line forced out through an air vent in open communication with an air turbine as water level rises.
